(19) United States
(12) Patent Application Publication
(10) Pub. No.: US 2007/0261533 A1
(43) Pub. Date: Nov. 15, 2007

(54) ELECTRONIC CONDUCTOR TO ASSIST PEOPLE IN PLAYING MUSIC

(76) Inventor: Diane L. Marshall, Plainsboro, NJ (US)

Correspondence Address: STANLEY H. KREMEN, 4 LENAPE LANE, EAST BRUNSWICK, NJ, 08816, US

(21) Appl. No.: 11/383,368

(22) Filed: May 15, 2006

(51) Int. Cl. G09B 15/02

(52) U.S. Cl. 84/477 R

(57) ABSTRACT

A signaling device for use by a musical conductor to transmit individualized cues to musicians playing in concert. The main utility exists where the musicians are disabled and cannot receive cues from a conductor in the usual manner. The device comprises a switch console for use by the conductor, an information actuator, and remote cueing indicators, at least one for each musician. The preferred embodiment of the switch console is a keyboard. When the conductor depresses a particular key, a cue is sent to a corresponding musician. The cues can tell the musician when to start and stop playing. They can also denote desired rhythms and volumes. Musicians who play multiple musical instruments in the same concert would have multiple cueing devices that would each relate to a specific instrument.

### BACKGROUND

1. The Problem to be Solved

The role of a musical conductor is to interpret a piece of music and convey that interpretation to a group of musicians in such a way that the musicians play the piece as interpreted by the conductor. To accomplish this, the conductor commands the timing and the rhythm and cues the musicians when to begin and end playing their instruments. The conductor also controls the volume of the music played by the individual musicians. An orchestra without a conductor will play music that sounds like a cacophony.

Learning to play a musical instrument is very important for the emotional development of disabled persons. It was long thought that children who were blind (or otherwise visually impaired), deaf (or otherwise hearing impaired), or developmentally disabled would not be able to play music together with other disabled children in concert. Yet it would be emotionally gratifying for these children and their parents were the children to be able to perform in concert. A normal orchestra, band, or ensemble needs a conductor to play together. This requirement is magnified for an ensemble comprising a plurality of disabled children. A conductor waving a baton would have great difficulty communicating with these musicians. Visually impaired musicians would not be able to see the conductor's movements. Hearing impaired musicians would not be able to hear the other musicians' music in a manner sufficient to accurately maintain proper rhythm. Finally, developmentally disabled musicians would not be able to interpret a normal conductor's baton and hand movements.

Therefore, a musical conductor directing such disabled musicians in a concert requires some device that would enable all of the musicians, regardless of their disparate disabilities, to play their instruments together in order to properly interpret the musical piece. The Present Invention disclosed herein acts as a cueing device that permits a conductor to send signals to individual musicians which informs them when to start and stop playing and to maintain appropriate rhythm and volume. Where a musician plays more than one instrument, the device signals them as to which instrument to play.

In the drawings and description of the invention, emphasis has been placed upon the children playing bells. Such a bell concert requires the ringing of many bells, each having a different musical pitch, in proper sequence to play the musical piece. Each child has two bells of different pitch (i.e., different musical instruments), and is cued by the conductor when to ring each bell. Of course, any musical instrument (or multiple instruments) may be substituted for the bells.

2. Discussion of the Prior Art

Musical display devices have existed since the turn of the century. J. M. Loring patented his “musical chromoscope” in 1901 (U.S. Pat. No. 667,541) in which a series of electric light bulbs were mounted on top of a piano. The bulbs were equal in number to the number of keys in a piano keyboard. When a piano key is manually depressed, the corresponding light bulb emits light. In the preferred embodiment, the lights are colored. So, a piano player produces a light show by playing a musical piece. Similar inventions, such as those by E. M. Schantz (U.S. Pat. Nos. 1,324,274; 1,324,275; 1,324,267; and 1,324,277), use electrical signals (generated from contact with player piano rolls) to instruct students in piano playing by lighting small light bulbs that cue the student to depress a given piano key. G. A. McAleavey (U.S. Pat. No. 1,613,400) used a remote keyboard to cue students to depress a corresponding piano key. Other instruments such has organs, xylophones and guitars have been equipped with cueing devices. Japanese inventor, Eisaku Okamoto (U.S. Pat. No. 3,784,717), patented an electronic “group teaching system for musical instruments incorporated with information exchanging arrangement between a teacher station and a plurality of student stations.” Kenneth Scott (U.S. Pat. No. 3,823,637) invented a “programmed audio-visual teaching aid” for teaching students to play musical instruments. It provided a series of programmed lessons onto a number of receiving stations operated by students. It combined audio and video lessons to be followed by the students in learning to read music and to play their instruments. More recently, devices to teach students to play a keyboard musical instrument have been computer actuated. In 1996, Gair Linhart (U.S. Pat. No. 5,576,505) invented a “music prompter for indicating note/chord changes to developmentally disabled individuals or orchestras.”

### Patentability of the Present Invention over the Prior Art

With one exception, the relevant prior art teaches devices designed to enable a normal student to play a piece of music on a musical instrument. Most of these devices attach to pianos, and have lights that indicate which key to depress to produce a programmed sound. These devices are not very different from player pianos which automatically play programmed musical pieces without the aid of a musician. Their difference lies in that a person can sit at the piano and feel that he or she is playing the piece. Actually, the person does no more to play the piece than to follow the instructions from a piano roll. Other prior art devices attach to instruments different from pianos, such as guitars and xylophones. However, they work in the same way. Finally, one device allows a teacher to interact with a single student. The teacher and the student both have keyboards, and the student mimics the teacher, thereby actually learning to play the piano.

The Present Invention permits a musical conductor to address an ensemble having a plurality of musicians. The main utility of the Present Invention is for musicians having various disabilities. The Present Invention is distinguished over the prior art by permitting selection of the correct cueing device to enable a particular musician to play in concert. So, a visually impaired musician could use a vibrator, and a hearing impaired person could use a light bulb, etc. The cueing devices would normally be located remotely from the conductor's console. Each musician would have a cueing device suited to his or her needs. The second distinction over the prior art is that the cueing device is not required to tell the musician what musical notes to play. This drawings and detailed description discuss a concert where a plurality of children are ringing bells, each bell being capable of sounding a different musical note. However, the Present Invention has many more uses. A more sophisticated musician with a disability may know how to play a musical passage on his or her instrument, but may not be able to synchronize playing his or her instrument with the other musicians. For example, a blind musician cannot see the conductor, and a deaf musician cannot hear the other musicians thereby making musical synchronization difficult. Beethoven was deaf in his later years, but he could play any musical piece. However, even he would need visual cues to enable him to play in an orchestra. The Present Invention permits a conductor to communicate with individual musicians according to their individual needs, to signal them when to start and stop playing, and to convey rhythm and volume cues as well. Finally, a musician who plays different musical instruments during the same musical piece would have multiple cueing devices, one for each instrument. So, a percussionist might have one remote device for snare drums, another for a kettle drum, and another for cymbals.

### SUMMARY OF THE INVENTION

The invention disclosed herein is a switch console along with remote cueing devices to permit a musical conductor to communicate with individual musicians who are playing in concert. The main utility of this device is where musicians are disabled and cannot receive their cues from the conductor in the usual manner. A blind musician cannot observe the hand movements of a conductor, and a deaf musician cannot hear the rest of the orchestra. Therefore, the cueing device is selectable based upon each musicians specific disability. The cueing device for a visually impaired musician could be a vibrator, while the cueing device for a hearing impaired musician could be a light bulb or LED. Different musicians would have different cueing devices, depending upon individual needs. The preferred embodiment of the switch console is a keyboard which is operated by the conductor. Depressing a particular key activates a specific remote cueing device. Information as to when to start and stop playing as well as rhythm and volume cues can be transmitted to individual musicians.

### BRIEF DESCRIPTION OF THE DRAWINGS

FIG. 1 is an isometric view of the device comprising manually activated keys and remote devices.

FIG. 2 is a schematic showing how depressing a key activates a remote device.

FIG. 3 shows how the device is coded to cause a plurality of children to ring one of two bells.

FIG. 4 shows a child having a remote device on each wrist.

FIG. 5 is an isometric view of a remote device.

FIG. 6 shows wireless operation of a remote device.

### DETAILED DESCRIPTION OF THE PREFERRED AND ALTERNATE EMBODIMENTS

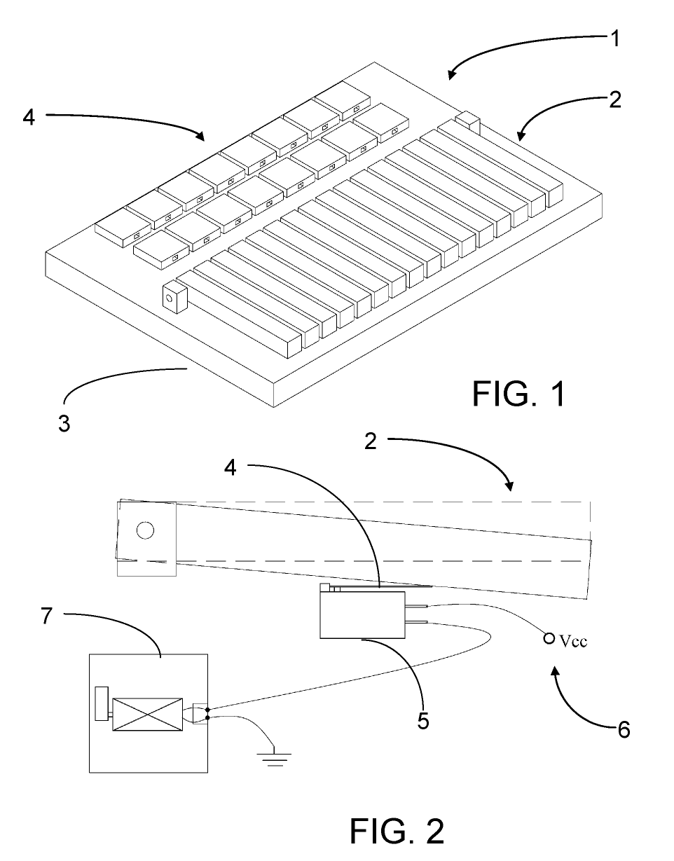

The Present Invention disclosed herein is a signaling device for use by a musical conductor to transmit individualized cues to multiple musicians. FIG. 1 is shows the signaling device 1 which comprises manually activated keys 2, a chassis 3, and remote devices or enunciators 4. It also comprises a power supply 6 (not shown in the figure). As shown in FIG. 2, when a single key 2 is depressed it moves flexible lever 4 into contact with microswitch 5 which is powered by power supply 6. This causes activation of remote device 7, which in this case is a vibrating assembly. The remote device, or enunciator, 4, may be a vibrator, a light, a mechanical signal, or a device that emits an audio signal (such as a pair of audio headphones). Upon receiving a cueing signal, the remote device would be seen, heard, or felt by an individual musician. The remote device can be connected to the keyboard chassis using electric wires, or using a mechanical device. It may also be activated by a wireless connection. Finally, it could be a mechanical signal such as a flag that is displayed upon cueing.

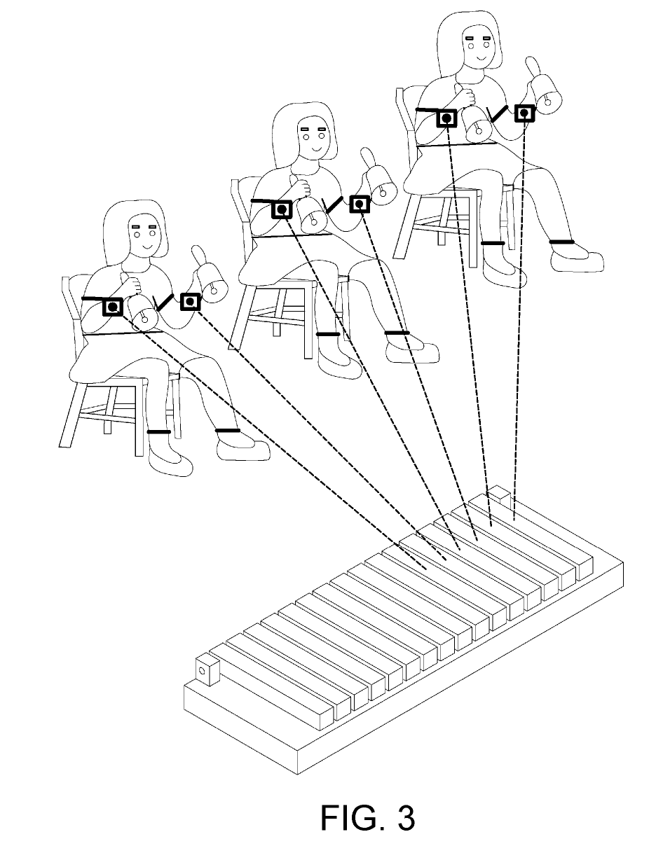

FIG. 3 shows a plurality of young musicians, each holding two bells, one in each hand. Each student wears two vibrators 7, one on each wrist. Depressing the rightmost key causes the vibrator on the left wrist of the rightmost musician to vibrate, thereby cueing that musician to ring the bell with her left hand. Depressing the next adjacent key causes the vibrator on the right wrist of the same musician to vibrate, thereby cueing that musician to ring the bell with her right hand. Similarly, the next two adjacent keys cue the musician in the middle, and the next two adjacent keys cue the leftmost musician. The keyboard can be fabricated with any desired number of keys, designed to cue any desired number of musicians to play any desired number of musical instruments.

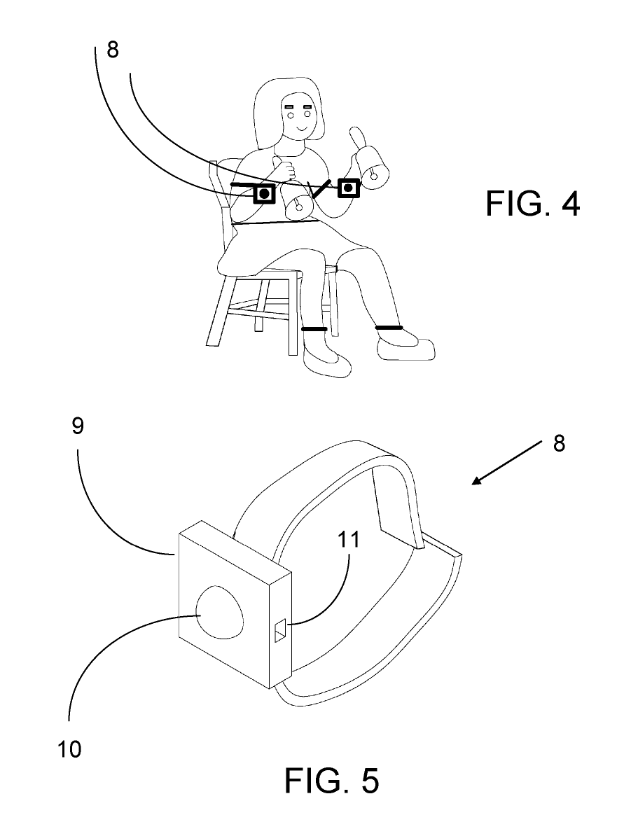

FIG. 4 shows a single young musician holding two bells, one in each hand, and wearing two vibrator and light assemblies 8, also one on each arm. FIG. 5 shows the detail for such a remote device 8. The device is held to the musicians arm using a strap. The device further comprises a vibrator 9, a light 10, and a female receptacle for a wire male connector.

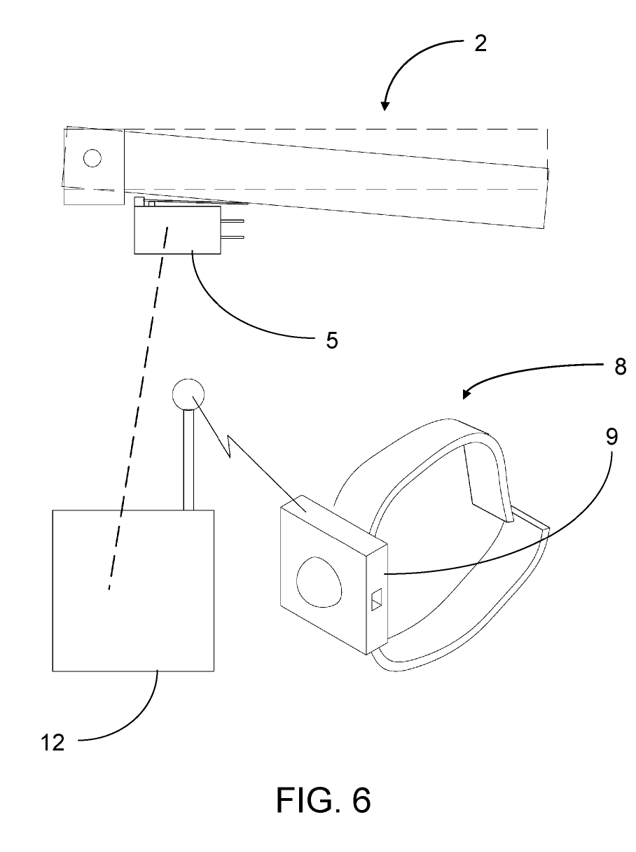

FIG. 6 shows the situation where depressing key 2 activates microswitch 5 thereby activating wireless transmitter 12 which then sends a cueing signal to vibrator 9 of remote device 8.

Of course, a keyboard, while typical and preferred, can be replaced by another type of switch panel. The switches may be activated by electronic signals instead of mechanical means. Furthermore, the cues may be momentary or sustained. Also, the remote device could be a panel board of lights, where each musician watches specific lights which act as individualized cueing signals when lit.

### Glossary

The Applicant intends to act as her own lexicographer regarding her disclosure herein of the Present Invention. Therefore, the definitions of terms provided here supersede the ordinary usage for these terms:
INFORMATION ACTUATOR—A device that translates activation of at least one switch into at least one signal that can transmitted.
CUEING INDICATOR—A device that creates a signal that can be understood by a musician as a cue.

I claim:

1. A signaling device for use by a musical conductor to transmit individualized cues to at least one musician, comprising:
a) a switch panel comprising at least one switch;
b) an information actuator; and,
c) at least one cueing indicator for each switch wherein each cueing indicator is of the type selected as desired from the group consisting of:
i) a device that produces a visual signal;
ii) a device that produces an audio signal; and,
iii) a device that produces a tactile signal,
whereby a conductor may transmit a signal to be perceived as a cue by the musician.

2. The device of claim 1 further comprising a plurality of switches that activate a plurality of cueing indicators.

3. The device of claim 2 wherein the cueing indicators are distributed so as to cue a plurality of musicians.

4. The device of claim 2 wherein the cueing indicators are distributed so as to cue a musician to play at least one of a plurality of musical instruments.

5. The device of claim 1 wherein the switch panel comprises mechanical switches, electronic switches, or a combination of mechanical and electronic switches.

6. The device of claim 1 wherein the switch is activated by mechanically depressing a key.

7. The device of claim 6 wherein activation can signal a momentary cue.

8. The device of claim 6 wherein activation can signal a sustained cue.

9. The device of claim 2 further comprising a keyboard.

10. The device of claim 1 wherein the information actuator is a mechanical device.

11. The device of claim 1 wherein the information actuator is an electric wire.

12. The device of claim 1 wherein the information actuator is a wireless transmitter.

13. The device of claim 1 wherein the cueing indicator creates a visual cue.

14. The device of claim 13 wherein the visual cue is created by a light.

15. The device of claim 1 wherein the cueing indicator creates a tactile cue.

16. The device of claim 15 wherein the tactile cue is created by a vibrator.

17. The device of claim 1 wherein the cueing indicator creates an audible cue.

18. The device of claim 1 wherein the cueing indicator is worn by the musician.
